(19) United States
(12) Patent Application Publication
(10) Pub. No.: US 2012/0267961 A1
(43) Pub. Date: Oct. 25, 2012

(54) WIRELESS POWER SUPPLY APPARATUS

(75) Inventors: Yuki Endo, Tokyo (JP); Yasuo Furukawa, Tokyo (JP)

(73) Assignee: ADVANTEST CORPORATION, Tokyo (JP)

(21) Appl. No.: 13/433,244

(22) Filed: Mar. 28, 2012

Related U.S. Application Data
(60) Provisional application No. 61/478,023, filed on Apr. 21, 2011.

(51) Int. Cl. H02J 17/00

(52) U.S. Cl. 307/104

(57) ABSTRACT

A resonance circuit includes a transmission coil and a resonance capacitor connected in series. A multi-tone power supply is capable of selecting arbitrary frequency components from among multiple discrete frequency components, and outputs, to the resonance circuit, a multi-tone signal obtained by superimposing sine wave signals of the respective frequency components thus selected. In a measurement mode, a frequency control circuit sets all the frequency components for the multi-tone power supply, and selects at least one frequency component at which the electric power transmission efficiency is high in the state in which a multi-tone signal is generated by superimposing the sine wave signals of all the frequencies. In a power supply mode, the aforementioned at least one frequency component thus selected in the measurement mode is set for the multi-tone power supply.

### BACKGROUND OF THE INVENTION

1. Field of the Invention

The present invention relates to a wireless power supply technique.

2. Description of the Related Art

In recent years, wireless (contactless) power transmission has been receiving attention as a power supply technique for electronic devices such as cellular phone terminals, laptop computers, etc., or for electric vehicles. Wireless power transmission can be classified into three principal methods using an electromagnetic induction, an electromagnetic wave reception, and an electric field/magnetic field resonance.

The electromagnetic induction method is employed to supply electric power at a short range (several cm or less), which enables electric power of several hundred watts to be transmitted in a band that is equal to or lower than several hundred kHz. The power use efficiency thereof is on the order of 60% to 98%.

In a case in which electric power is to be supplied over a relatively long range of several meters or more, the electromagnetic wave reception method is employed. The electromagnetic wave reception method allows electric power of several watts or less to be transmitted in a band between medium waves and microwaves. However, the power use efficiency thereof is small. The electric field/magnetic field resonance method has been receiving attention as a method for supplying electric power with relatively high efficiency at a middle range on the order of several meters (see Non-patent document 1).

### RELATED ART DOCUMENTS

### Patent Documents

[Non-patent document 1]
A. Karalis, J. D. Joannopoulos, M. Soljacic, “Efficient wireless non-radiative mid-range energy transfer” ANNALS of PHYSICS Vol. 323, January 2008, pp. 34-48.

FIG. 1 is a diagram which shows an example of a wireless power supply system. The wireless power supply system 2r includes a wireless power supply apparatus 4r and a wireless power receiving apparatus 6r.

The wireless power supply apparatus 4r includes a transmission coil L_{TX}, a resonance capacitor C_{TX}, and an AC power supply 20r. The AC power supply 20r is configured to generate an electric signal S2 having a transmission frequency f₁. The resonance capacitor C_{TX} and the transmission coil L_{TX} form a transmission antenna that is a resonance circuit having a resonance frequency that is tuned to the frequency of the electric signal S2. The transmission coil L_{TX} is configured to output an electric power signal S1. As such an electric power signal S1, the wireless power supply system 2r uses the near-field components (electric field, magnetic field, or electromagnetic field) of electromagnetic waves that have not yet become radio waves.

The wireless power receiving apparatus 6r includes a reception coil L_{RX}, a resonance capacitor C_{RX}, and a load 3. The resonance capacitor C_{RX}, the reception coil L_{AX}, and the load 3 form a resonance circuit. The resonance frequency of the resonance circuit thus formed is tuned to the frequency of the electric power signal S1.

FIG. 2 is a graph which shows the transmission characteristics (S21) of the power supply system shown in FIG. 1, which represents electric power transmission from the AC power supply to the load. When the distance or otherwise the direction between the transmission coil L_{TX} and the reception coil T_{RX} changes, the coupling coefficient K between the two coils changes. When the coupling coefficient K becomes high, the waveform of the transmission characteristics S21 changes such that a single peak is split into two peaks. The peak interval changes according to the coupling coefficient K.

With such a conventional power supply system 2r, by adjusting the capacitances of the resonance capacitors C_{TX} and C_{RX}, such an arrangement allows the resonance frequency of the receiver-side resonance circuit and the resonance frequency of the transmitter-side resonance circuit to be tuned to be in the vicinity of a peak at which high transmission efficiency can be obtained.

However, in a situation in which the distance between the power supply apparatus 4r and the power receiving apparatus 6r changes over time, i.e., in a situation in which the coupling coefficient K changes over time, it is difficult to adjust the resonance capacitors C_{TX} and C_{RX} such that they follow the change in the coupling coefficient K.

### SUMMARY OF THE INVENTION

The present invention has been made in order to solve such a problem. Accordingly, it is an exemplary purpose of an embodiment of the present invention to provide a wireless power supply apparatus which is capable of maintaining high-efficiency electric power transmission even if the coupling coefficient between a transmission coil and a reception coil changes.

An embodiment of the present invention relates to a wireless power supply apparatus configured to transmit an electric power signal including any one from among an electric field component, a magnetic field component, and an electromagnetic field component. The wireless power supply apparatus comprises: a resonance circuit comprising a transmission coil and a resonance capacitor connected in series; a multi-tone power supply configured to be capable of setting desired frequency components from among multiple discrete frequency components, and to output, to the resonance circuit, a multi-tone signal obtained by superimposing sine wave signals of the respective frequency components thus set; and a frequency control circuit configured to set the frequency components of the sine wave signals to be output by the multi-tone power supply. In a measurement mode, the frequency control circuit sets all the frequency components for the multi-tone power supply, and determines at least one frequency component at which the electric power transmission efficiency is high in such a state in which a multi-tone signal is generated by superimposing sine wave signals of all the frequencies. In a power supply mode, the frequency control circuit sets, for the multi-tone power supply, the aforementioned at least one frequency component determined in the measurement mode.

Such an embodiment is capable of providing electric power transmission using a suitable frequency band at which the electric power transmission efficiency is high without changing the resonance frequency on the power supply side or the resonance frequency on the power receiving side even in a situation in which, due to the coupling coefficient, the frequency bands at which the power transmission efficiency is high are split.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows an example of a wireless power supply system;

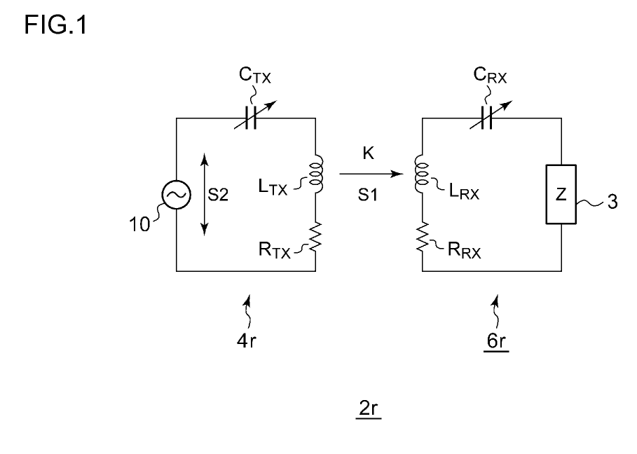

FIG. 2 is a graph which shows the transmission characteristics (S21) of the power supply system shown in FIG. 1, which represents electric power transmission from an AC power supply to a load;

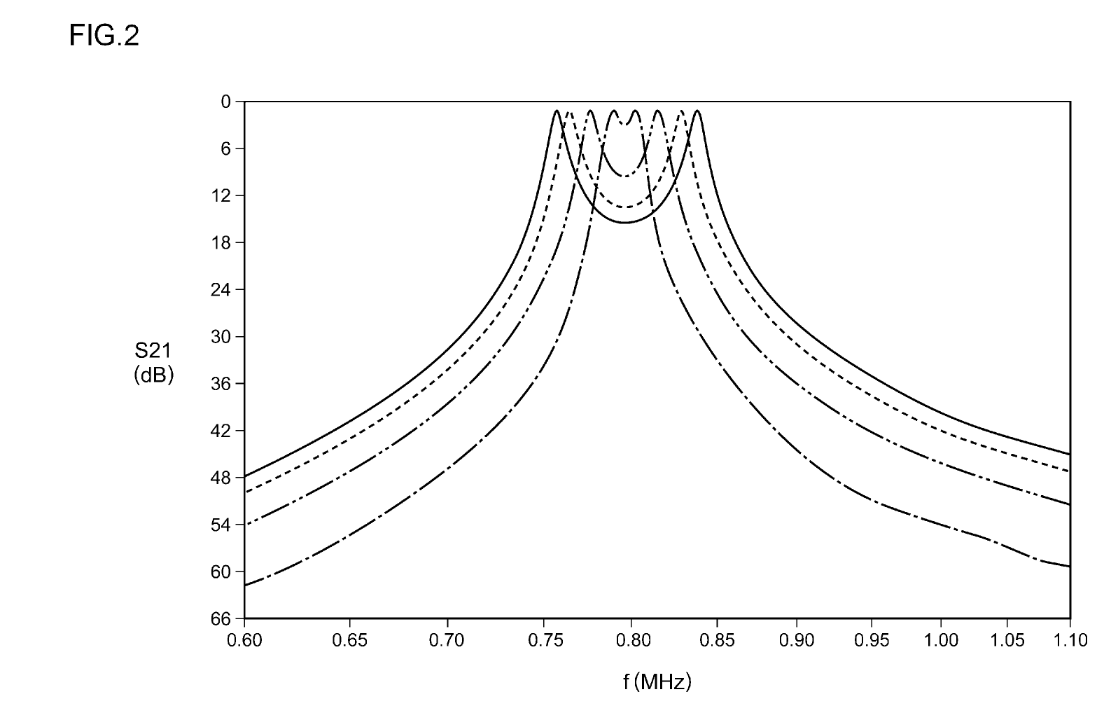

FIG. 3 is a block diagram which shows a configuration of a wireless power supply apparatus according to an embodiment;

FIG. 4 is a circuit diagram which shows a specific configuration of a wireless power supply apparatus;

FIGS. 5A through 5E are diagrams each showing the operation of the wireless power supply apparatus according to the embodiment;

FIG. 6 is a circuit diagram which shows a configuration of a wireless power supply apparatus according to a first modification;

FIG. 7 is a circuit diagram which shows a part of a configuration of a wireless power supply apparatus according to a third modification;

FIG. 8 is a circuit diagram which shows a part of a configuration of a wireless power supply apparatus according to a seventh modification;

FIG. 9 is a diagram which shows a power supply system employing the wireless power supply apparatus according to an eighth modification; and

FIGS. 10A through 10C are diagrams each showing the operation of the power supply system shown in FIG. 9.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not substantially affect the electric connection therebetween, or that does not damage the functions or effects of the connection therebetween, in addition to a state in which the member A is physically and directly connected to the member B.

Similarly, the state represented by the phrase “the member C is provided between the member A and the member B” includes a state in which the member A is indirectly connected to the member C, or the member B is indirectly connected to the member C via another member that does not substantially affect the electric connection therebetween, or that does not damage the functions or effects of the connection therebetween, in addition to a state in which the member A is directly connected to the member C, or the member B is directly connected to the member C.

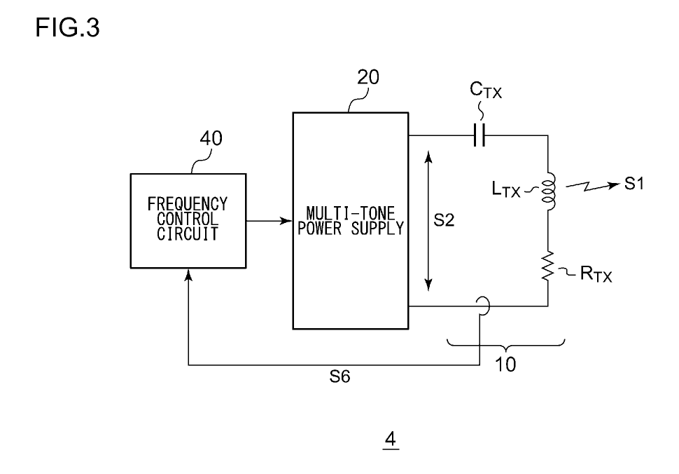

FIG. 3 is a block diagram which shows a configuration of a wireless power supply apparatus 4 according to an embodiment. The power supply apparatus 4 includes a resonance circuit 10, a multi-tone power supply 20, and a frequency control circuit 40, and is configured to output an electric power signal S1 to an unshown wireless power receiving apparatus. The electric power signal S1 is configured as a near-field component (electric field, magnetic field, or electromagnetic field) of electromagnetic waves that has not become radio waves.

The resonance circuit 10 includes a transmission coil L_{TX} and a resonance capacitor C_{TX} connected in series. The resistor R_{TX} represents a resistance component of the frequency circuit.

The multi-tone power supply 20 is configured to be capable of selecting desired frequencies from among multiple discrete frequencies f₁ through f_{N}, and to output, to the resonance circuit 10, a multi-tone signal S2 obtained by superimposing sine wave signals of the respective frequencies thus set. Here, N represents an integer of 2 or more. The multiple frequencies f₁ through f_{N} are determined such that they are distributed around a center that matches the resonance frequency f_{R} of the resonance circuit 10.

The frequency control circuit 40 is configured to set the frequency of the sine wave signal to be output from the multi-tone power supply 20. The frequency control circuit 40 is configured to be switchable between the measurement mode and the power supply mode.

In the measurement mode, the frequency control circuit 40 sets all the frequencies f₁ through f_{N} for the multi-tone power supply 20. In this state, such an arrangement instructs the multi-tone power supply 20 to generate a multi-tone signal S2a obtained by superimposing the sine wave signals of all the frequencies f₁ through f_{N}. It should be noted that electric power transmission is not performed using the multi-tone signal S2a, and accordingly, the amplitude of the sine wave of each frequency is set to be sufficiently small. In this state, based upon a detection signal S6 which indicates the electrical state of the resonance circuit 10, the frequency control circuit 40 determines at least one frequency at which high power transmission efficiency can be obtained.

In the power supply mode, the frequency control circuit 40 sets, for the multi-tone power supply 20, at least one frequency determined in the measurement mode. Preferably, the frequency control circuit 40 sets two frequencies fᵢ and fⱼ for the multi-tone power supply 20. In this case, in the power supply mode, the multi-tone power supply 20 generates a multi-tone signal S2b obtained by superimposing sine wave signals of two respective frequencies fᵢ and f₃ at which high power transmission efficiency can be obtained. That is to say, electric power supply is performed using the frequencies fᵢ and fⱼ. The amplitudes of the respective sine wave signals having the frequencies fᵢ and fⱼ thus used to generate the multi-tone signal S2b are set to be sufficiently higher than those of the sine wave signals of all the frequencies used in the measurement mode. In the power supply mode, the number of frequencies set for the multi-tone power supply 20 is not restricted to two. Rather, the number of frequencies set for the multi-tone power supply 20 may be determined as desired.

The multi-tone power supply 20 preferably superimposes the multiple sine wave signals of the multiple respective frequencies f₁, f₂, and so forth, set by the frequency control circuit 40, with respective phases such that their respective phases result in the multi-tone signal S2 exhibiting a low crest factor.

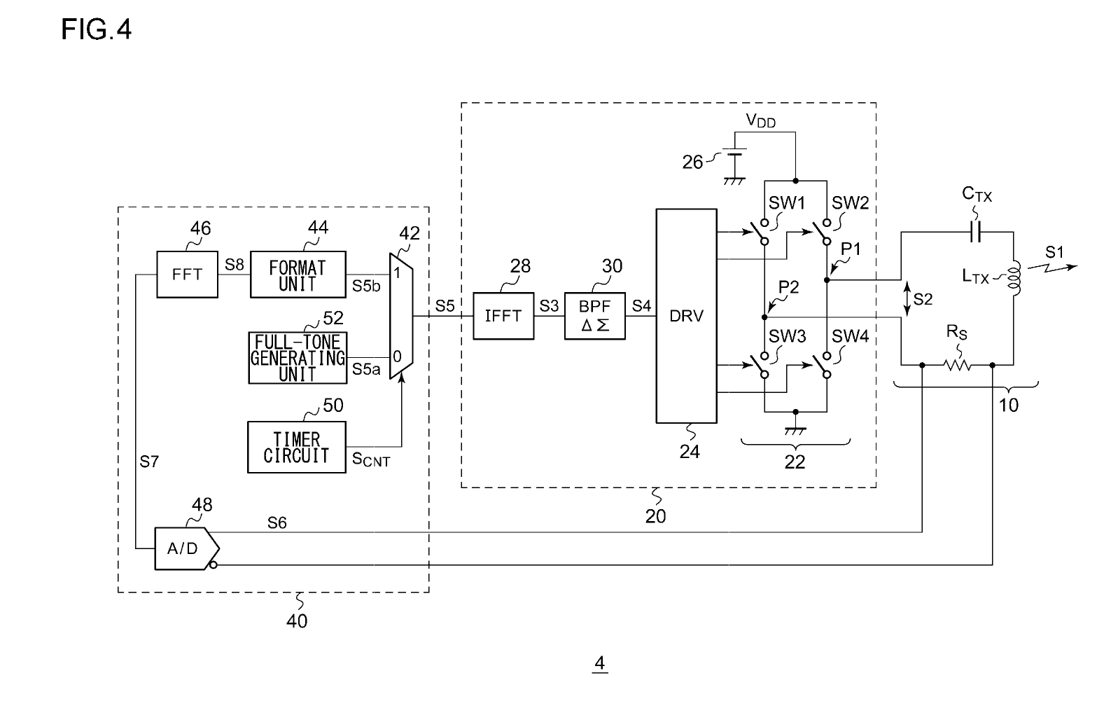

FIG. 4 is a circuit diagram which shows a specific configuration of the wireless power supply apparatus 4.

The multi-tone power supply 20 includes a bridge circuit 22, a driver circuit 24, a power supply 26, a digital multi-tone signal generating unit 28, and a bitstream signal generating unit 30.

The output terminals P1 and P2 of the bridge circuit 22 are connected to the resonance circuit 10. In FIG. 4, the bridge circuit 22 is configured as an H-bridge circuit, and includes four switches SW1 through SW4.

The power supply 26 is configured to output a power supply voltage V_{DD} to the bridge circuit 22.

The digital multi-tone signal generating unit 28 is configured to generate a digital multi-tone signal S3 having a waveform obtained by superimposing the sine wave signals of the frequencies set by the frequency control circuit 40. For example, the digital multi-tone signal generating unit 28 receives frequency data S5 set by the frequency control circuit 40. The frequency data S5 is configured as complex data which represents both the amplitude information and the phase information for each frequency. The digital multi-tone signal generating unit 28 includes an inverse fast Fourier transformer configured to calculate an inverse Fourier transform of the frequency data S5 so as to generate the digital multi-tone signal S3.

The bitstream signal generating unit 30 is configured to generate the bitstream signal S4 according to the digital multi-tone signal S3. For example, the bitstream signal generating unit 30 includes a bandpass delta-sigma modulator configured to generate a bitstream signal S4 by performing delta-sigma modulation on the digital multi-tone signal S3.

Such a bandpass delta-sigma modulator may be configured using known techniques. The bandpass delta-sigma modulator is designed such that the bandpass center frequency fc of a bandpass filter included within the bandpass delta-sigma modulator matches the resonance frequency f_{R} of the resonance circuit 10. By means of oversampling, the bandpass delta-sigma modulator is configured to generate the bitstream signal S4 at a rate that is four times the bandpass center frequency fc.

The digital multi-tone signal S3, which is input to the bitstream signal generating unit 30, involves quantization noise which is uniformly distributed over the entire band. The digital multi-tone signal S3 is shaped (subjected to noise shaping) by the bandpass delta-sigma modulator such that the quantization noise exhibits a value that is at a minimum in the vicinity of the frequency fc, and that increases as the frequency changes from the frequency fc.

The driver circuit 24 is configured to drive the switches SW1 through SW4 of the bridge circuit according to the bitstream signal S4.

Specifically, when the bitstream signal S4 is a first level (e.g., high level), the driver circuit 24 turns on a pair of switches SW1 and SW4. When the bitstream signal S4 is a second level (e.g. low level), the driver circuit 24 turns on a pair of switches SW2 and SW3.

The frequency control circuit 40 receives the detection signal S6 that corresponds to the resonance current I_{L} that flows through the resonance circuit 10. For example, the resonance circuit 10 includes a detection resistor Rs arranged in series with the resonance capacitor C_{TX} and the transmission coil L_{TX}. The voltage drop Vs, which is proportional to the resonance current I_{L}, occurs at the detection resistor Rs. The voltage drop Vs is input as the detection signal S6 to the frequency control circuit 40. The frequency control circuit 40 selects a large intensity frequency component from among the frequency components contained in the detection signal S6, and sets the frequency component thus selected for the multi-tone power supply 20.

The frequency control circuit 40 includes a selector 42, a format unit 44, a fast Fourier transformer 46, an A/D converter 48, a timer circuit 50, and a full-tone generating unit 52.

The timer circuit 50 is configured to switch the mode between the measurement mode and the power supply mode for each predetermined period. For example, the timer circuit 50 is configured to generate a control signal S_{CNT} that is set to low level (0) in the measurement mode, and that is set to high level (1) in the power supply mode.

As described above, in the measurement mode, the frequency control circuit 40 sets all the frequencies for the multi-tone power supply 20. The full-tone generating unit 52 is configured to generate the frequency data S5a that is required to generate a multi-tone signal S2a of which all the frequency components have a uniform amplitude. As described above, the phases of the respective frequency signals are preferably adjusted such that the multi-tone signal S2a exhibits a low crest factor.

In a case in which the multi-tone power supply 20 is configured employing such a bridge circuit 22, the amplitude of the multi-tone signal S2 is limited by the power supply voltage V_{DD} generated by the power supply 26. By optimizing the phases of the respective frequency signals such that the multi-tone signal S2 exhibits a low crest factor, such an arrangement allows the amplitude to be increased for each frequency component, thereby allowing the transmittable electric power to be increased. The same can be said of an arrangement in which the multi-tone power supply 20 is configured employing an analog amplifier.

The A/D converter 48 is configured to convert the detection signal S6 into a digital signal S7. The fast Fourier transformer 46 performs a Fourier transform on the digital signal S7. The format unit 44 determines, based upon the output data S8 of the fast Fourier transformer 46, the frequency to be set for the multi-tone power supply 20 in the following power supply mode. Specifically, the format unit sets, for the multi-tone power supply 20, multiple frequencies at which the output data S8 thus subjected to the Fourier transform exhibits high signal magnitude. The format unit 44 is configured to determine the phases of the respective frequency signals such that the multi-tone signal exhibits a low crest factor, and to generate frequency data S5b.

The frequency data S5a and S5b are input to the selector 42. In the measurement mode, the selector 42 selects the frequency data S5a. In the power supply mode, the selector 42 selects the frequency data S5b.

The above is the configuration of the wireless power supply apparatus 4.

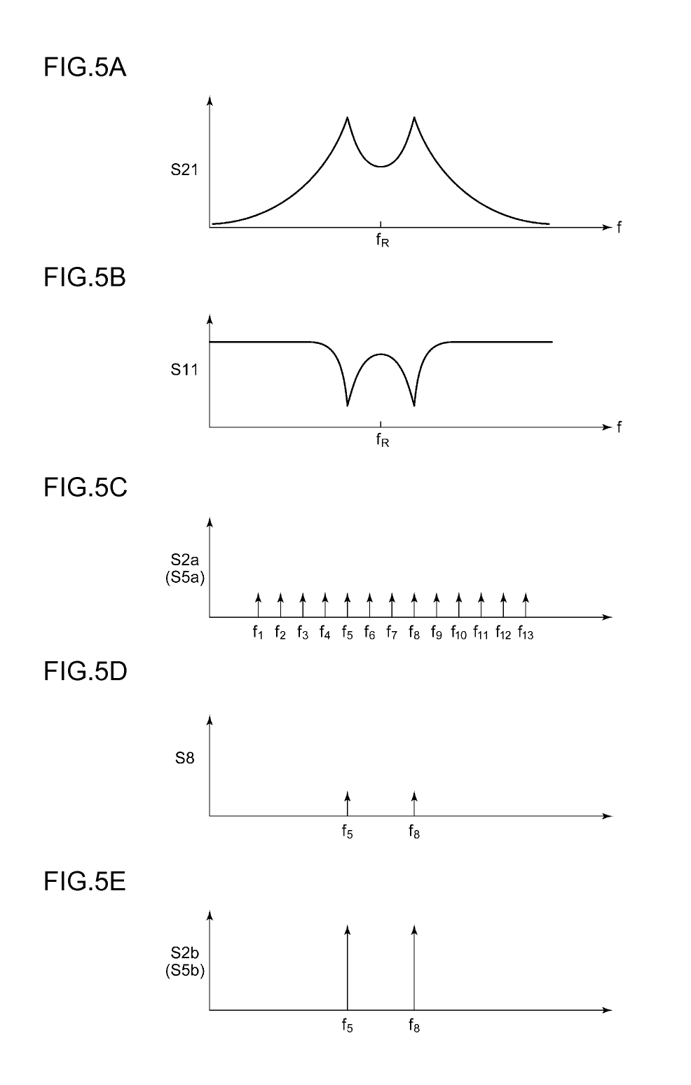

Next, description will be made regarding the operation thereof. FIGS. 5A through 5E are diagrams each showing the operation of the wireless power supply apparatus 4 according to an embodiment. The coupling coefficient K between the transmission coil L_{TX} and the reception coil L_{RX} changes according to the distance and the direction between the wireless power supply apparatus 4 and the wireless power receiving apparatus 6. With such an arrangement, the S parameter (transmission characteristics) S21, which represents the characteristics of electric power transmission from the multi-tone power supply 20 to the load of the wireless power receiving apparatus 6, changes according to the coupling coefficient K.

FIGS. 5A and 5B respectively show the S parameters S21 (transmission characteristics) and S11 (reflection characteristics) at a certain coupling coefficient K. In the measurement mode, the frequency control circuit 40 sets all the frequencies for the multi-tone power supply 20. As a result, such an arrangement generates the multi-tone signal S2a having a spectrum as shown in FIG. 5C. When the multi-tone signal S2a having such a spectrum as shown in FIG. 5C is applied to the resonance circuit 10, the resonance current I_{L} becomes large at a frequency at which electric power can be efficiently transmitted to the wireless power receiving apparatus 6. That is to say, the magnitude of the output data S8 generated by the fast Fourier transformer 46 becomes high at a frequency at which power transmission can be performed with high efficiency. The format unit 44 determines the frequencies f₅ and f₈, the magnitudes of which are high, to be the frequencies to be used in the following power supply mode. In the power supply mode, as shown in FIG. 5E, such an arrangement generates the multi-tone signal S2a having the frequency components f₅ and f₈.

The wireless power supply apparatus 4 is switched to the measurement mode for each predetermined period according to a control signal S_{CNT} received from the timer circuit 50. The wireless power supply apparatus 4 is configured to select optimum frequencies for each cycle, and thus to supply electric power to the wireless power receiving apparatus 6.

The above is the operation of the power supply apparatus 4.

The wireless power supply apparatus 4 according to the embodiment is configured to measure the spectrum of the resonance current I_{L} that flows through the resonance circuit 10, thereby detecting the frequencies at which electric power can be transmitted with high efficiency to the wireless power receiving apparatus 6.

Furthermore, by switching the mode between the power supply mode and the measurement mode for each predetermined period, such an arrangement is capable of appropriately switching the frequency components that form the multi-tone signal S2b, thereby always providing high-efficiency electric power transmission even if the wireless power supply apparatus 4 and the wireless power receiving apparatus 6 move relative to each other.

Furthermore, the wireless power supply apparatus 4 shown in FIG. 3 is configured to employ the bridge circuit to generate the multi-tone signal S2. Thus, such an arrangement is capable of generating the electric power signal S1 with high efficiency as compared with an arrangement employing a linear amplifier.

Moreover, a bandpass delta-sigma modulator is employed in the bitstream signal generating unit 30, the center frequency fc of which matches the resonance frequency f_{R} of the resonance circuit 10. As a result, quantization noise in the digital multi-tone signal S3 is distributed over a range that is outside the band of the bandpass filter. Such an arrangement is capable of appropriately performing filtering of the digital multi-tone signal S3 by means of the resonance circuit 10.

Description has been made regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

### [Modification 1]

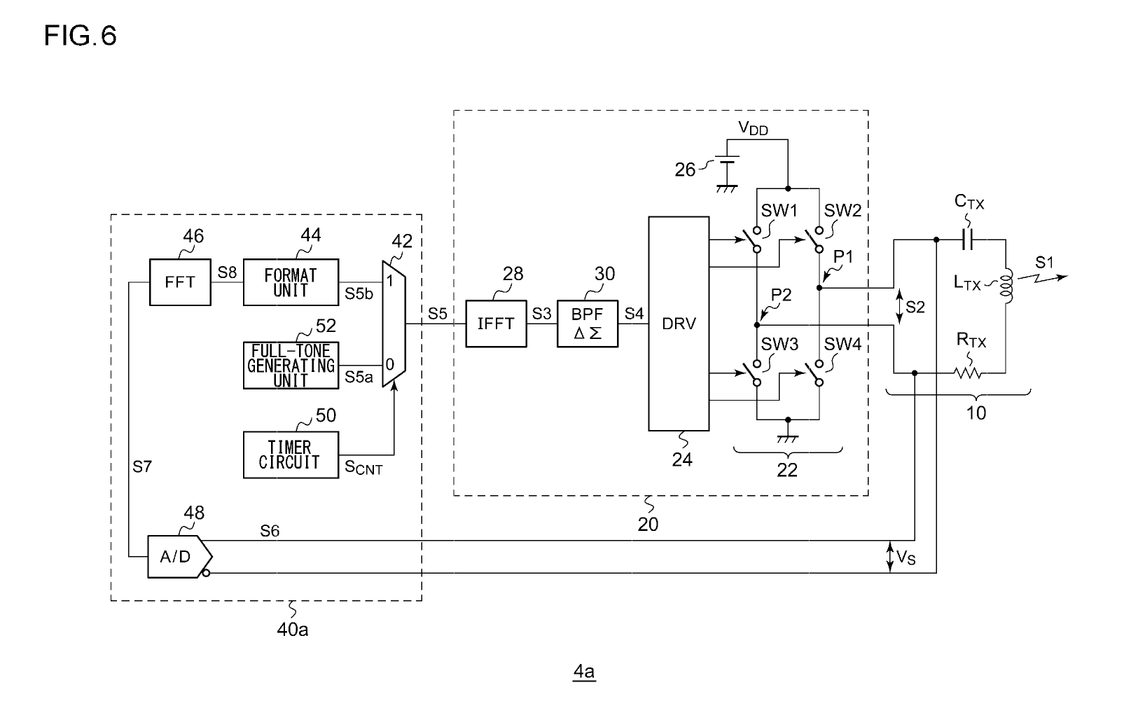

FIG. 6 is a circuit diagram which shows a configuration of a wireless power supply apparatus 4a according to a first modification. The wireless power supply apparatus 4a is configured to generate a detection signal S6a that corresponds to the voltage Vs across the resonance circuit 10, instead of a detection signal that corresponds to the resonance current I_{L}. With such an arrangement, from among the frequency components contained in the detection signal S6a, the frequency control circuit 40a selects the frequencies the magnitudes of which are small, and sets the frequency components thus selected for the multi-tone power supply 20 in the following step.

With such a modification, a sine wave signal having a frequency component that has not been transmitted to the wireless power receiving apparatus is reflected by the resonance circuit 10. As a result, the detection voltage Vs across the resonance circuit 10 becomes large at a frequency at which the transmission efficiency is low. Conversely, the detection voltage Vs becomes small at a frequency at which the transmission efficiency is high. Thus, by calculating the Fourier transform of the detection voltage Vs, such an arrangement is capable of determining the frequencies suitable for electric power transmission.

[Modification 2]

Also, the power supply 26 may be configured to modulate the power supply voltage V_{DD} according to the digital multi-tone signal S3. In this case, the power supply 26 and the bridge circuit 22 can be regarded as a polar modulator.

In a case in which the power supply voltage V_{DD} is configured as a fixed voltage, the multi-tone signal S2a has a completely square waveform. Thus, the spectrum of the multi-tone signal S2a contains a large number of sideband components. In contrast, by appropriately modulating the power supply voltage V_{DD} according to the waveform of the multi-tone signal S2, such a modification is capable of suppressing such sideband components. Thus, such a modification is capable of further suppressing noise outside the band, or otherwise providing increased efficiency.

[Modification 3]

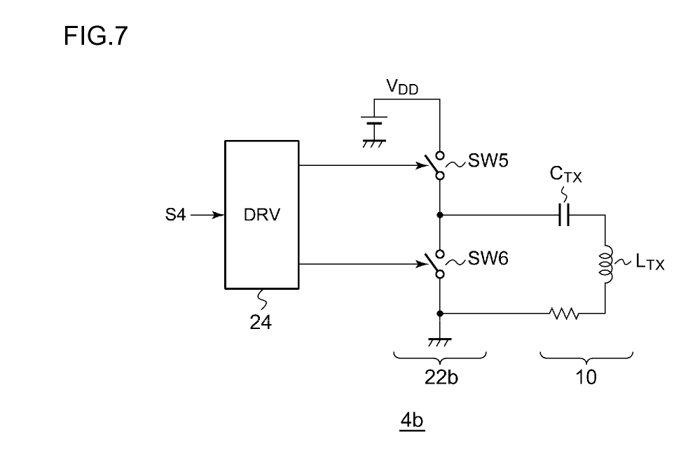

FIG. 7 is a circuit diagram which shows a part of a configuration of a wireless power supply apparatus 4b according to a third modification. The wireless power supply apparatus 4b includes a half-bridge circuit as a bridge circuit 22b. When the bitstream signal S4 is a first level (high level), the driver circuit 24 turns on a switch SW5, and when the bitstream signal S4 is a second level (low level), the driver circuit 24 turns on a switch SW6.

Such a modification also provides the same advantages as in an arrangement employing an H-bridge circuit.

[Modification 4]

Description has been made in the embodiment regarding an arrangement in which the mode is switched between the measurement mode and the power supply mode in a time sharing manner. However, the present invention is not restricted to such an arrangement. Also, the optimum frequencies suitable for electric power transmission may be detected while supplying power. With such a modification, the frequency control circuit 40 is configured to output frequency data obtained by superimposing the frequency data S5a and S5b. Specifically, the frequency characteristics are measured by generating a signal having at least weak magnitude over all the frequencies. At the same time, the signal magnitude is increased at the frequencies used for power transmission.

[Modification 5]

Description has been made in the embodiment regarding an arrangement in which the A/D converter 48 and the fast Fourier transformer 46 are used to measure the frequency characteristics of the electric power transmission. However, the present invention is not restricted to such an arrangement. Also, a selective level meter may be employed to measure the magnitudes of the respective frequency components f₁ through f_{N}.

[Modification 6]

The multi-tone power supply 20 may be configured as an analog linear amplifier. For example, the multi-tone power supply 20 may be configured including a D/A converter configured to convert the digital multi-tone signal S3 into an analog multi-tone signal, and an analog amplifier (buffer) configured to output the output signal of the D/A converter to the resonance circuit 10. Such a configuration allows such a modification to output, to the resonance circuit 10, a multi-tone signal obtained by superimposing sine wave signals of multiple frequencies.

[Modification 7]

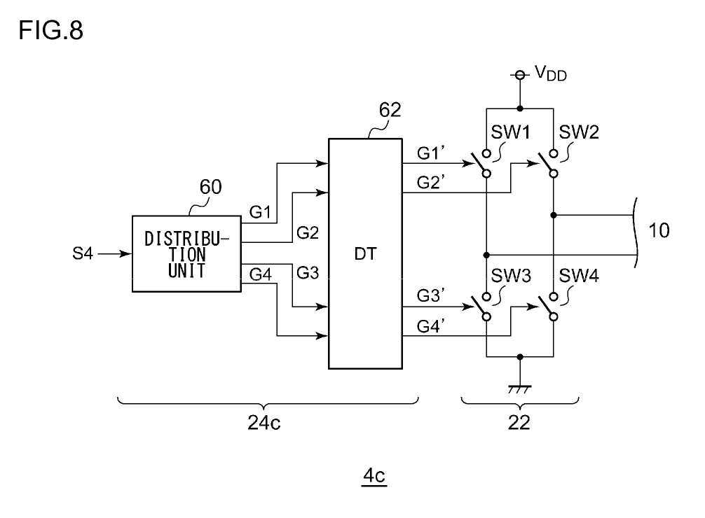

FIG. 8 is a circuit diagram which shows a part of a configuration of a wireless power supply apparatus 4c according to a seventh modification. The driver circuit 24c includes a distribution unit 60 and a dead time setting unit 62. The distribution unit 60 is configured to generate gate signals G1 through G4 for the respective switches SW1 through SW4, according to the bitstream signal S4. For example, when the bitstream signal S4 is high level, the gate signals G1 and G4 are each set to a level which functions as an instruction to turn on the switches SW1 and SW4. When the bitstream signal S4 is low level, the gate signals G2 and G3 are each set to a level which functions as an instruction to turn on the switches SW2 and SW3.

The dead time setting unit 62 is configured to reduce, by a predetermined dead time T_{DT} for each cycle of the bitstream signal, the on time set for the respective switches SW1 through SW4. With such an arrangement, during a period of dead time T_{DT}, all the switches SW1 through SW4 are turned off. The dead time setting unit 62 is configured to be capable of adjusting the length of the dead time T_{DT}.

The dead time T_{DT} is used to control the resonance frequency, in addition to being used to suppress a so-called through current. The dead time setting unit 62 is configured to adjust the length of the dead time T_{DT} such that partial resonance occurs between the resonance circuit 10 and the multi-tone signal S2 or the resonance current I_{L} that corresponds to the multi-tone signal S2.

Using such partial resonance, such a modification is capable of changing the effective resonance frequency of the resonance circuit 10 according to the length of the dead time T_{DT} without changing the circuit constants of the transmission coil L_{TX} and the resonance capacitor C_{TX} of the resonance circuit 10.

[Modification 8]

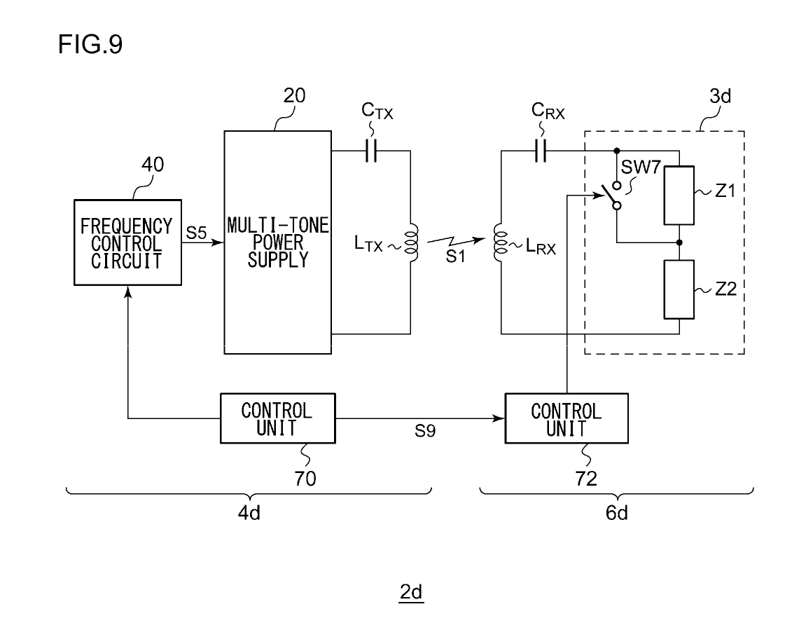

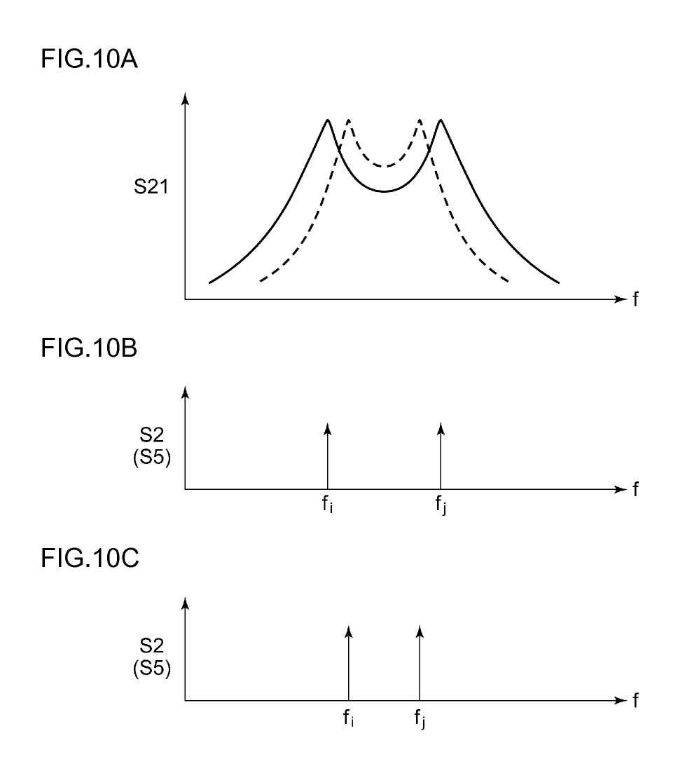

FIG. 9 is a diagram which shows a power supply system 2d employing a wireless power supply apparatus 4d according to an eighth modification. FIGS. 10A through 10C are diagrams showing the operation of the power supply system 2d shown in FIG. 9.

The control unit 70 of the wireless power supply apparatus 4d is configured to switch the frequency components fᵢ and fⱼ to be set for the multi-tone power supply 20 at a predetermined cycle or at random, which is switched between multiple states as shown in FIGS. 10B and 10C.

The load 3d of the wireless power receiving apparatus 6d is configured to have a variable impedance. The configuration of the load 3d is not restricted in particular. For example, the load 3d may include loads Z1 and Z2, and a switch SW7. When the switch SW7 is turned on, the impedance of the load 3d becomes lower than the impedance in the state in which the switch SW7 is off. When the impedance of the load 3d is changed, the frequency at which high-efficiency electric power transmission can be performed changes, as indicated by the solid line and the broken line in FIG. 10A.

With such a system, such an arrangement enables electric power transmission only in a state in which the switching of the multi-tone signal S2 frequency by means of the wireless power supply apparatus 4d and the switching of the load 3d by means of the wireless power receiving apparatus 6d are synchronously controlled.

That is to say, the wireless power supply apparatus 4d outputs a synchronous signal S9 including the information required for synchronous control to only a particular wireless power receiving apparatus 6d that has permission to receive the power supply. The control unit 72 which receives a valid synchronous signal S9 performs switching of the load 3d impedance in synchronization with the frequency switching performed by the frequency control circuit 40.

Such a system allows the wireless power supply apparatus 4d to permit or to inhibit the electric power supply to the wireless power receiving apparatus 6d.

[Modification 9]

Given information may be superimposed on the multi-tone signal S2. The superimposition of such information can be performed by applying amplitude modulation, phase modulation, or the like, to the sine wave signals of the respective frequencies to be superimposed. For example, the synchronization signal S9 described in the modification 8 may be superimposed on the multi-tone signal S2 itself.

[Modification 10]

Description has been made regarding an arrangement employing delta-sigma modulation. Also, the bridge circuit 22 may be driven using other modulation methods such as pulse width modulation.

While the preferred embodiments of the present invention have been described using specific terms, such description is for illustrative purposes only, and it is to be understood that changes and variations may be made without departing from the spirit or scope of the appended claims.

What is claimed is:

1. A wireless power supply apparatus configured to transmit an electric power signal including any one from among an electric field component, a magnetic field component, and an electromagnetic field component, the wireless power supply apparatus comprising:
a transmission antenna comprising a transmission coil;
a power supply configured to be capable of setting arbitrary frequency components from among multiple frequency components, and to output, to the transmission antenna, a multi-tone signal obtained by superimposing sine wave signals of the respective frequency components thus set; and
a frequency control circuit configured to set the frequency components of the sine wave signals to be output by the power supply,
wherein, in a measurement mode, the frequency control circuit determines at least one frequency component at which the electric power transmission efficiency is high in such a state in which the frequency control circuit sets a plurality of frequency components for the power supply,
and wherein, in a power supply mode, the frequency control circuit sets, for the power supply, the aforementioned at least one frequency component determined in the measurement mode.

2. A wireless power supply apparatus according to claim 1, wherein the power supply comprises:
a bridge circuit connected to the transmission coil;
a power supply circuit configured to output a power supply voltage to the bridge circuit;
a digital multi-tone signal generating unit configured to generate a digital multi-tone signal having a waveform obtained by superimposing sine wave signals of the respective frequencies set by the frequency control circuit;
a bitstream signal generating unit configured to generate a bitstream signal that corresponds to the digital multi-tone signal; and
a driver circuit configured to drive the bridge circuit according to the bitstream signal.

3. A wireless power supply apparatus according to claim 2, wherein the bitstream signal generating unit is configured to perform delta-sigma modulation on the digital multi-tone signal so as to generate the bitstream signal.

4. A wireless power supply apparatus according to claim 2, wherein the digital multi-tone signal generating unit comprises an inverse fast Fourier transformer configured to perform an inverse Fourier transform on frequency data set by the frequency control circuit so as to generate the digital multi-tone signal.

5. A wireless power supply apparatus according to claim 2, wherein the power supply circuit is configured to modulate the power supply voltage according to the digital multi-tone signal.

6. A wireless power supply apparatus according to claim 1, wherein the frequency control circuit is configured to select a frequency component having a large magnitude from among frequency components contained in a detection signal that corresponds to a current that flows through the transmission antenna, and to set the frequency component thus selected for the power supply.

7. A wireless power supply apparatus according to claim 1, wherein the frequency control circuit is configured to select a frequency component having a small magnitude from among frequency components contained in a detection signal that corresponds to a voltage across the transmission antenna, and to set the frequency component thus selected for the power supply.

8. A wireless power supply apparatus according to claim 6, wherein the frequency control circuit comprises:
an A/D converter configured to convert the detection signal into a digital signal;
a fast Fourier transformer configured to perform a Fourier transform on the digital signal; and
a format unit configured to determine, based upon output data of the fast Fourier transformer, the frequency component to be set for the power supply in the following power supply mode.

9. A wireless power supply apparatus according to claim 7, wherein the frequency control circuit comprises:
an A/D converter configured to convert the detection signal into a digital signal;
a fast Fourier transformer configured to perform a Fourier transform on the digital signal; and
a format unit configured to determine, based upon output data of the fast Fourier transformer, the frequency component to be set for the power supply in the following power supply mode.

10. A wireless power supply apparatus according to claim 1, wherein the power supply is configured to superimpose sine wave signals of the respective frequency components set by the frequency control circuit, with respective phases such that the multi-tone signal exhibits a small crest factor.

11. A wireless power supply apparatus according to claim 1, wherein the frequency control circuit is configured to be switched to the measurement mode for each predetermined period.

12. A wireless power supply apparatus according to claim 1, wherein the frequency control circuit is configured to perform the measurement mode operation while performing the power supply mode operation.

13. A wireless power supply system comprising:
a wireless power supply apparatus configured to transmit an electric power signal including any one of an electric field component, a magnetic field component, and an electromagnetic field component; and
a wireless power receiving apparatus configured to receive the electric power signal, wherein
the wireless power supply apparatus comprises:
a transmission antenna comprising a transmission coil;
a power supply configured to be capable of setting arbitrary frequency components from among multiple frequency components, and to output, to the transmission antenna, a multi-tone signal obtained by superimposing sine wave signals of the respective frequency components thus set; and
a frequency control circuit configured to set the frequency components of the sine wave signals to be output by the power supply,
wherein, in a measurement mode, the frequency control circuit sets a plurality of frequency components for the power supply, and determines at least one frequency component at which the electric power transmission efficiency is high in such a state in which a multi-tone signal is generated by superimposing sine wave signals of the plurality of frequency components,
and wherein, in a power supply mode, the frequency control circuit sets, for the power supply, the aforementioned at least one frequency component determined in the measurement mode.
